(19) United States
(12) Patent Application Publication
(10) Pub. No.: US 2004/0065345 A1
(43) Pub. Date: Apr. 8, 2004

(54) Method for cleaning substrate

(76) Inventor: Hironori Kobayashi, Shinjuku-ku (JP)

Correspondence Address: WILDMAN, HARROLD, ALLEN & DIXON, 225 WEST WACKER DRIVE, CHICAGO, IL, 60606, US

(21) Appl. No.: 10/459,668

(22) Filed: Jun. 11, 2003

(30) Foreign Application Priority Data
Jun. 13, 2002 (JP) 2002-173162

(51) Int. Cl. B08B 3/10

(52) U.S. Cl. 134/1.3; 134/2; 134/25.4; 134/26

(57) ABSTRACT

A main object of the present invention is to provide a method for cleaning a substrate, in which a substrate surface can be cleaned by an easy and efficient process without causing any undesirable influence on the substrate. The present invention achieves the aforementioned object by providing a method for cleaning a substrate, wherein a substrate to be cleaned and a photocatalyst containing layer containing a photocatalyst, which is formed on a base material, are placed with no clearance or with a clearance between each other, and then, a surface of the substrate is cleaned by irradiating an energy from a predetermined direction.

### BACKGROUND OF THE INVENTION

1. Field of the Invention

The present invention relates to a method for cleaning a substrate used for an organic EL substrate or the like.

2. Description of the Related Art

Cleaning of residues attached to an organic EL substrate which has been subjected to pattern formation by photolithography has conventionally been carried out by UV irradiation on the entire surface. In this cleaning by UV, a method of decomposing or volatilize by oxidizing organic substances attached to the substrate surface, by using a lamp such as a low pressure mercury lamp or an excimer lamp, is used.

However, when UV is irradiated on the entire surface of the substrate, UV with a strong energy is irradiated on portions other than the portions with residues which needs to be cleaned. That is, there is a possibility that the substrate is affected by the irradiated energy, depending on the types of the substrate and the patterns formed on the substrate. Thus, there exists restriction on the types of substrate and patterns.

In order to solve this problem, a method in which UV irradiation is effected only on the portions with residues, by using a photomask or the like, is proposed. However, it is generally difficult to apply, to a photomask, UV light having a wavelength effective for such cleaning as described above. Therefore, there are cases in which a photomask cannot be used.

### SUMMARY OF THE INVENTION

Due to the problems described above, there is a demand for a method for cleaning a substrate, in which a substrate surface can be cleaned by an easy and efficient process without causing any undesirable influence on the substrate.

The present invention provides a method for cleaning a substrate, wherein a substrate to be cleaned and a photocatalyst containing layer containing a photocatalyst, which is formed on a base material, are placed with no clearance or with a clearance between each other, and then, a surface of the substrate is cleaned by irradiating an energy from a predetermined direction.

According to the present invention, by placing a substrate to be cleaned and a photocatalyst containing layer formed on a base material, with no clearance or with a certain clearance between each other, irradiating a common type of energy such as UV, a surface of the substrate can be cleaned. Thus, use of a light source at a specific wavelength having strong energy is not necessary, the cleaning can be completed in a short time and further, it is advantageous in term of the cost.

In the above mentioned invention, it is preferable that the substrate is formed with an inorganic material. By forming the substrate with an inorganic material, the substrate is stable to the above mentioned energy irradiation.

Further, in the abovementioned invention, it is preferable that the photocatalyst containing layer is a layer consisting of a photocatalyst. In a case in which the photocatalyst containing layer is a layer consisting of a photocatalyst, sensitivity is excellent and efficient cleaning of the substrate surface can be carried out.

Yet further, in the above mentioned invention, it is preferable that the photocatalyst containing layer is a photocatalyst film formed on the base material by a vacuum film forming method. By forming the photocatalyst containing layer by the vacuum film forming method, a thin film having even thickness consisting of only the photocatalyst can be formed and thus cleaning of a substrate surface can efficiently be carried out.

In the above mentioned invention, the photocatalyst containing layer may be a layer comprising the photocatalys and a binder.

Thus, when the photocatalyst containing layer comprises the photocatalyst and the binder, the photocatalyst containing layer can be formed easily, which is advantageous in terms of cost.

Further, in this case, it is preferable that the binder is an organopolysiloxane which is 1 kind, or 2 or more kinds of hydrolysis condensates or cohydrolysis condensates of silicon compounds represented by YₙSiX₍₄₋ₙ₎ (wherein Y denotes an alkyl group, a fluoroalkyl group, a vinyl group, an amino group, a phenyl group, an epoxy group, or an organic group containing the above, X denotes an alkoxyl group or halogen, and n is an integer of 0 to 3). Such a binder can firmly fixing the photocatalyst in the photocatalyst containing layer, and also allows easy formation of the photocatalyst containing layer.

In any of the aforementioned aspects of the invention, it is preferable that the photocatalyst is 1 kind, or 2 or more kinds of materials selected from titanium dioxide (TiO₂), zinc oxide (ZnO), tin oxide (SnO₂), strontium titanate (SrTiO₃), tungsten oxide (WO₃), bismuth oxide (Bi₂O₃) or iron oxide (Fe₂O₃). Among these substances, titanium oxide (TiO₂) is particularly preferable as the photocatalyst, because titanium dioxide has high band gap energy, it is effective as a photocatalys, chemically stable, exhibits no toxicity and is easily available.

In the above mentioned invention, the cleaning of the substrate surface may be carried out on the entire surface, because the cleaning of the surface of the substrate such as an organic EL substrate is generally carried out on the entire surface.

Further, the above mentioned cleaning of the substrate surface above may be carried out in a pattern. In the method for cleaning of a substrate according to the present invention, by carrying out the cleaning, for example, only on the portions to which residues are attached, it is possible to avoid irradiating the energy to the portion at which energy irradiation is not necessary.

In this case, a method for cleaning the substrate surface in a pattern by forming the photocatalyst containing layer in a pattern on the base material; a method for cleaning the substrate surface in a pattern by forming a light shielding portion in a pattern on the surface of the photocatalyst containing layer; a method for cleaning the substrate surface in a pattern by forming a light shielding portion in a pattern on the base material; and a method for cleaning the substrate surface in a pattern by irradiating the energy by photo drawing irradiation can be listed.

In any of the aforementioned aspects of the invention, the energy irradiation may be carried out while the photocatalyst containing layer is being heated. By cleaning a substrate surface with a photocatalyst containing layer being heated, the sensitivity of the photocatalyst containing layer can be improved.

Further, it is preferable that the photocatalyst containing layer and the substrate surface are placed so as a clearance between each other is in a range of 0.2 to 10 μm, and then the energy is irradiated. By irradiating the energy with the clearance in the abovementioned range, cleaning of the surface can be carried out more effectively.

The present invention provides an organic EL substrate, which is cleaned by a method for cleaning a substrate according to any of the aforementioned aspects of the invention. By employing such a method for cleaning a substrate as described above, an organic EL substrate is cleaned by an easy and efficient process which is preferable in terms of cost, therefore, an organic EL substrate of high quality can be obtained.

### BRIEF DESCRIPTION OF THE DRAWINGS

FIG. 1 is a view showing one example of the method for cleaning a substrate according to the present invention.

FIG. 2 is a view showing another example of the method for cleaning a substrate according to the present invention.

FIG. 3 is a view showing still another example of the method for cleaning a substrate according to the present invention.

FIG. 4 is a view showing still another example of the method for cleaning a substrate according to the present invention.

FIG. 5 is a view showing still another example of the method for cleaning a substrate according to the present invention.

FIG. 6 is a view showing still another example of the method for cleaning a substrate according to the present invention.

### DESCRIPTION OF THE PREFERRED EMBODIMENTS

The method for cleaning a substrate of the present invention is a method wherein a substrate to be cleaned and a photocatalyst containing layer containing a photocatalyst, which is formed on a base material, are placed with no clearance or with a clearance between each other, and then, a surface of the substrate is cleaned by irradiating an energy from a predetermined direction.

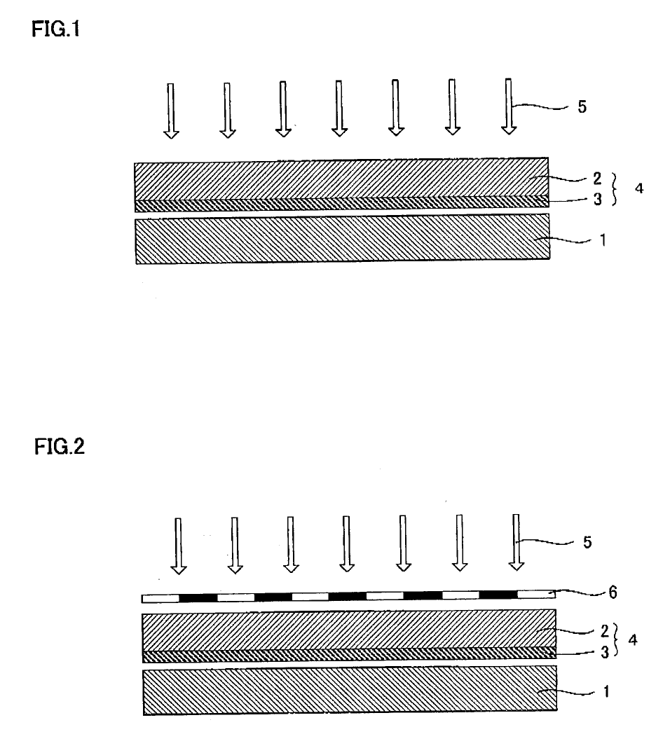

According to the present invention, for example, as shown in FIG. 1, by placing a substrate 1 and a photocatalyst treatment material 4 comprising a photocatalyst containing layer 3 formed on the base material 2, with a certain clearance between each other, and irradiating energy 5 from a predetermined direction, the surface of the substrate 1 can be cleaned. This method for cleaning a substrate will be described hereafter.

In the present invention, the photocatalyst treatment material represents a member comprising a base material provided so as to face the substrate to be cleaned, and a photocatalyst containing layer formed on the base material.

(Substrate)

First, the substrate which can be cleaned by the present invention will be described. The material and the like of the substrate which can be cleaned by the present invention is not particularly limited, as long as the substrate is stable to energy irradiation, and an organic material such as teflon (registered trademark) and the like may be used. Among them, an inorganic material is particularly preferable. By forming the substrate with inorganic material, the substrate is more stable to the energy irradiation. Specific examples of such an inorganic material include a metal material such as gold, silver, copper, iron and the like, in addition to an inorganic material such as silicon, glass, ceramics and the like.

The substrate which can be cleaned by the present invention may be either transparent or colored, or may be reflective. Also, the substrate may be the one which is subjected to a surface treatment such as a surface treatment for preventing alkali-elution and a surface treatment for providing a surface with gas-barrier property.

(Photocatalyst Containing Layer)

Next, the photocatalyst containing layer used in the present invention will be described.

In the method for cleaning a substrate of the present invention, a photocatalyst containing layer, containing a photocatalyst, formed on a base material is used as a photocatalyst treatment material. The photocatalyst containing layer is not particularly limited as long as the layer contains a photocatalyst. Specifically, the photocatalyst containing layer may be consisting of only the photocatalyst, or may comprise the photocatalyst and the binder.

The mechanism of the action of a photocatalyst, which is typically represented by titanium dioxide described below, in a photocatalyst containing layer is not clearly known to the full extent. It is assumed that a carrier, generated by irradiation of light, directly reacts with nearby compounds, or active oxygen species generated in the presence of oxygen and water effects the chemical structure of an organic substance. In the present invention, it is assumed that this carrier acts on organic substances such as residues attached to the substrate placed in the vicinity of the photocatalyst containing layer. The effect of substrate cleaning of the present invention can be confirmed by a decrease in the contact angle of the cleaned substrate to water, compared with the contact angle of the substrate before cleaning.

In a case in which the photocatalyst containing layer is consisting of only the photocatalyst, the efficiency of cleaning the surface is improved and the treatment time is shortened, which is advantageous in terms of cost. On the other hand, in a case in which the photocatalyst containing layer is comprising the photocatalyst and the binder, there arises an advantage that the photocatalyst containing layer can be formed easily.

As the methods for forming a photocatalyst containing layer consisting of only the photocatalyst, method using a vacuum film forming method such as, for example, spattering, CVD method, and vacuum deposition method can be listed. By forming a photocatalyst containing layer by a vacuum film forming method, a photocatalyst containing layer which has even film thickness and consisting of only the photocatalyst can be obtained, whereby the surface of the substrate can be cleaned evenly and efficiently.

Further, in a case in which the photocatalyst is, for example, titanium dioxide, as the method of forming a photocatalyst containing layer which is consisting of only the photocatalyst, there is a method of forming amorphous titania on a base material and promoting a phase change to crystalline titania by baking. The amorphous titania used in this method can be obtained by hydrolysis or dehydration condensation of inorganic salts of titanium such as titanium tetrachloride or titanium sulfate, or hydrolysis or dehydration condensation of organic titanium compounds in the presence of an acid, such as tetraethoxy titanium, tetraisopropoxy titanium, tetra-n-propoxy titanium, tetrabutoxy titanium and tetramethoxy titanium. Next, the above can be denatured to anatase type titania by baking at 400 to 500° C., or can be denatured to rutile type titania by baking at 600 to 700° C.

In a case the photocatalyst containing layer comprises a photocatalyst and a binder, there is a method of forming a photocatalyst containing layer by the wet type method in a state which a binder is being mixed. It is preferable that the main skeleton of the binder used in this method has high bond energy as not to be discomposed by photo excitation of the aforementioned photocatalyst. Examples of such a binder include organopolysiloxane.

Examples of the photocatalyst used in such a photocatalyst containing layer include titanium dioxide (TiO₂), zinc oxide (ZnO), tin oxide (SnO₂), strontium titanate (SrTiO₃), tungsten oxide (WO₃), bismuth oxide (Bi₂O₃) and iron oxide (Fe₂O₃), which are known as photo semiconductors. And one kind, or two or more kinds can be selected from the aforementioned examples and may be used as a mixture.

In the present invention, titanium dioxide is particularly preferable, because titanium dioxide has high band gap energy, is chemically stable, exhibits no toxicity and is easily available. Titanium dioxide is classified into anatase type and rutile type. Although either type can be used in the present invention, titanium dioxide of anatase type is more preferable. The excitation wavelength of anatase type titanium dioxide is no larger than 380 nm.

Specific examples of the photocatalyst which is used with a binder to form a photocatalyst containing layer include anatase type titania sol of hydrochloric acid peptisation type (STS-02 (the average particle diameter is 7 nm) manufactured by Ishihara Sangyo Kaisha, Ltd., ST-K01, manufactured by Ishihara Sangyo Kaisha, Ltd.), anatase type titania sol of nitric acid peptisation type (TA-15 (the average particle diameter is 12 nm) manufactured by Nissan Chemical Industries, Ltd.).

In a case the photocatalyst is used with a binder to form a photocatalyst containing layer, the smaller the particle diameter of the photocatalyst is, the more effectively the photocatalyst reaction occurs and thus the more preferable. Use of a photocatalyst whose average diameter is 50 nm or less is preferable, and use of a photocatalyst whose average diameter is 20 nm or less is particularly preferable.

The the binder, used in a case the photocatalyst containing layer comprises a photocatalyst and a binder, is not particularly limited as long as the binder has a principal chain which is not likely to be deteriorated or discomposed by the action of the photocatalyst. Examples of the binder include organopolysiloxanes such as: (1) organopolysiloxane having high strength, obtained by hydrolyzing or polycondensating of chlorosilane or alkoxysilane by a sol-gel reaction or the like; and (2) organopolysiloxane obtained by crosslinking a reactive silicone which has excellent water repellency and oil repellency.

In the case of the aforementioned (1), the organopolysiloxane which is a hydrolysis condensate or a cohydrolysis condensate of 1 kind, or 2 or more kinds of silicon compound represented by general formula: YₙSiX₍₄₋ₙ₎ (wherein Y denotes an alkyl group, a fluoroalkyl group, a vinyl group, an amino group, a phenyl group, an epoxy group, or an organic group containing the above, X denotes an alkoxyl group, acetyl group, or halogen, and n is an integer of 0 to 3) is preferable. The number of carbon atoms of the organic group as a whole represented by Y is preferably in a range of 1 to 20. The alkoxy group represented by X is preferably methoxy group, ethoxy group, propoxy group and butoxy group. Polysiloxane comprising fluoroalkyl group is particularly preferable, and those generally known as a fluorine based silane coupling agent can be used.

About the specific materials and the like, the details are described in Japanese Patent Application Laid-Open (JP-A) 2000-249821 by the present inventors.

Examples of the reactive silicone described in the aforementioned (2) include compounds having a skeleton represented by the following general formula.

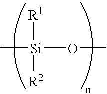

In the formula, n is an integer of 2 or more, R¹ and R² independently represent substituted or unsubstituted alkyl, alkenyl, aryl or cyanoalkyl group of 1 to 10 carbon number, and 40% or less, in mole ratio, of the whole is vinyl, phenyl and phenyl halide. R¹ and R² are preferably methyl groups because the surface energy thereof becomes the smallest. It is preferable that 60% or more, in mole ratio, is methyl group. Moreover, the molecular chain comprises at least one reactive group such as hydroxyl group at the chain terminal or the side chain.

Further, a stable organosilicone compound such as dimethylpolysiloxane, which is not crosslinked, may be mixed into the above mentioned organopolysiloxane.

In a case organopolysiloxane is used as the binder, the photocatalyst containing layer can be formed by preparing a coating solution by dissolving the photocatalyst and organopolysiloxane as the binder, optionally with other additives, in a solvent and coating the coating solution on a base material. As the solvent to be used, an alcohol base organic solvent such as ethanol, isopropanol or the like is preferable. Coating may be carried out by a known coating method including spin coating, spray coating, dip coating, roll coating, bead coating and the like. In a case a UV curing type component is contained as a binder, the photocatalyst containing layer can be formed by carrying out a curing treatment by irradiation of

Further, as the binder, an amorphous silica precursor can be used. This amorphous silica precursor is preferably a silicon compound represented by a general formula SiX₄, wherein X is halogen, methoxy group, ethoxy group, acetyl group, and the like, a silanol which is a hydrolysate thereof, or a polysiloxane whose average molecular weight is 3000 or less.

Specifically, tetraethoxysilane, tetraisopropoxysilane, tetra-n-propoxysilane, tetrabutoxysilane, tetramethoxysilane, and the like can be listed. In this case, a photocatalyst containing layer can be formed by: evenly dispersing the amorphous silica precursor and the particles of a photocatalyst in a non-aqueous solvent and hydrolyzing by the moisture in the air, to form silanol on a transparent substrate; and carrying out dehydration condensation polymerization at the room temperature. By carrying out the dehydration condensation polymerization of silanol at 100° C. or lower, the degree of polymerization of silanol is increased and the strength of the film surface can be improved. The above described binding agents may be used by itself, or by a mixture of 2 or more kinds.

The content of the photocatalyst in the photocatalyst containing layer may be set in a range of 5 to 60 mass %, preferably in a range of 20 to 40 mass %.

The film thickness of such a photocatalyst containing layer is preferably in a range of 0.01 to 0.2 μm, and more preferably in a range of 0.05 to 0.1 μm.

(Base Material)

Next, the base material of the photocatalyst treatment material will be described. In the method for cleaning a substrate of the present invention, the above mentioned photocatalyst containing layer is formed on the base material, and is subjected to the surface cleaning as the photocatalyst treatment material.

The material which constitutes the base material used here is appropriate selected depending on the energy irradiating direction in the energy irradiating process described below, or whether the substrate to be cleaned is transparent or not.

That is, as shown in FIG. 2, for example, irradiation of energy needs to be carried out from the base material side when energy 5 is irradiated in a pattern with a photomask 6 placed on the side of the base material 2 of the photocatalyst treatment material 4, or when energy is irradiated in a pattern with a light shielding portion is preliminary formed in a predetermined pattern on the base material, as described below. In these cases, the base material needs to be transparent.

On the contrary, when the substrate is made of a transparent material and energy is irradiated on the entire surface from the substrate side, or when irradiation is carried out in a pattern by using a photomask on the substrate side, transparency of the base material is not particularly required.

The base material used in the present invention may be either flexible such as a resin film, or inflexible such as a glass substrate. The type of the base material is appropriately selected in accordance with the energy irradiating method in the energy irradiating process described below.

As described above, the type of the base material used as the photocatalyst containing layer side base material of the present invention is not particularly limited. However, as the photocatalyst containing layer side base material is used repeatedly, in the present invention, a material which has a predetermined strength and whose surface exhibits excellent adhesion to the photocatalyst containing layer is preferably used.

Specifically, glass, ceramic, metal, plastic and the like can be presented.

An anchor layer may be formed on the base material in order to improve the adhesion property of the base material surface to the photocatalyst containing layer. Examples of such an anchor layer include a silane based coupling agent or a titanium base coupling agent.

(Energy Irradiation)

Next, irradiation of energy in the present invention will be described.

In the present invention, after the photocatalyst containing layer and the substrate are placed with no clearance or with a clearance between each other, a process in which energy is irradiated from a predetermined direction is carried out. In this process, energy irradiation may be carried out in a state in which the photocatalyst containing layer is in close contact with the substrate. The clearance between the photocatalyst containing layer and the substrate is preferably 2 mm or less, and more preferably 200 μm or less.

Further, in the present invention, the aforementioned clearance is preferably in a range of 0.2 to 10 μm and more preferably in a range of 1 to 5 μm in order to achieve high sensitivity of the photocatalyst, therefore, a high efficiency of cleaning. Such a range of clearance as described above is especially effective for a substrate having a small area which the clearance can be controlled with high precision.

On the contrary, in a case in which a substrate having a large area, for example, 300×300 mm, is treated, it is extremely difficult to provide such a minute clearance as described above in between the photocatalyst and the substrate, with being in contacted to each other. Accordingly, in a case in which the substrate has a relatively large area, the above mentioned clearance is preferably in a range of 10 to 100 μm, and more preferably in a range of 50 to 75 μm. By setting the clearance within the aforementioned range, a problem, that the sensitivity of the photocatalyst decreases and the efficiency of the cleaning is deteriorated, can be prevented and an effect of preventing irregularity in cleaning a substrate is obtained.

As described above, by placing the photocatalyst containing layer and the substrate surface such that there is a predetermined clearance between each other, the active oxygen species, generated from oxygen and water by the action of the photocatalyst, will be easily desorbed. That is, when the clearance between the photocatalyst containing layer and the substrate is made narrower than the aforementioned range, desorption of the above mentioned active oxygen species becomes more difficult and that possibly lead to the deterioration of the cleaning speed, which is not preferable. When the clearance between the photocatalyst containing layer and the substrate is wider than the aforementioned range, the generated active oxygen species is less likely to reach the substrate and that possibly lead to the deterioration of the cleaning speed, also in this case, which is not preferable.

In the present invention, it suffices if such configuration is maintained at least during the energy irradiation.

As a method of placing the photocatalyst containing layer and the substrate with evenly formed clearance which is extremely narrow as described above, a method of using a spacer, for example, can be listed. By using a spacer, a clearance can evenly be formed and also, the portions of the substrate surface, which the spacer contacts, is not influenced by the action of the photocatalyst. Accordingly, when cleaning in a pattern, by designing the spacer to have the same pattern as the predetermined pattern, cleaning of the substrate can be carried out in a pattern.

The term energy irradiation (exposure) used in the present invention is a concept including irradiation of any energy beam which can carry out the cleaning of a substrate surface by a photocatalyst containing layer, and is not limited to irradiation of visual light.

In general, the wavelength of light used for such energy irradiation as described above is set in a range of 400 nm or less, and preferably in a range of 380 nm or less. As described above, the preferable photocatalyst used for the photocatalyst containing layer is titanium dioxide, and light of the above described wavelength is preferable as the energy which activates the photocatalyst action of titanium dioxide.

Examples of a light source which can be used for the aforementioned energy irradiation include a mercury lamp, a metal halide lamp, a xenon lamp, an excimer lamp and other light sources of various types. By this, in the present invention, in addition to a low pressure mercury lamp, an excimer lamp or the like which are used in the conventional method for cleaning a substrate, a lamp with a high output can be used, whereby intended cleaning of a substrate can be completed in a short time.

Further, in addition to a method of using a light source as described above and carrying out a pattern irradiation via a photomask as described below, a method of drawing irradiation in a pattern by using lasers such as excimer, YAG, or the like, can be used.

The irradiating amount of energy in the energy irradiation is the irradiating amount of energy which is required for the substrate surface to be cleaned by the action of the photocatalyst in the photocatalyst containing layer.

Also, at this time, by irradiating energy while heating the photocatalyst containing layer, the sensitivity of the photocatalyst containing layer can be improved, and thus, it is preferable because the cleaning can be carried out more efficiently. Specifically, it is preferable to heated at a temperature within a range of 30 to 80° C.

(Cleaning Method)

Next, a method for cleaning a substrate, by using the above described substrate and photocatalyst treatment material, will be described.

In the present invention, by placing the aforementioned photocatalyst containing layer and the substrate with no clearance or a certain clearance between each other, and then irradiating energy thereon, the surface of the substrate can be cleaned efficiently and easily. The cleaning may be carried out either on the entire surface, or in a desired pattern. The cleaning of the entire surface is possible by irradiating energy in a state, as described above, in which photocatalyst containing layer and the substrate is placed with no clearance or a certain clearance between each other.

On the other hand, to clean the substrate in a pattern, there are a several methods. Specifically, there are:

(1) A method of using a photomask and irradiating energy thereon;

(2) A method of forming a pattern of the light shielding portion on the photocatalyst treatment material, and irradiating energy thereon from the side of the photocatalyst treatment material;

(3) A method of forming a photocatalyst containing layer in a pattern on the base material, and irradiating energy thereon; and

(4) A method of irradiating the energy by drawing irradiation.

Each of the aforementioned methods will be described hereinafter.

(1) A Method of Using a Photomask and Irradiating Energy Thereon

The present method is a method for cleaning of a substrate in a pattern by irradiating energy thereon using a photomask, when irradiating energy in a state, as above mentioned, in which the photocatalyst containing layer and the substrate are placed with no clearance or with a certain clearance between each other. For an example of this method, as shown in FIG. 2, a photocatalyst containing layer 3 formed on a base material 2 and a substrate 1 are placed with a certain clearance between each other. Further, a photomask 6 is placed on the base material 3 side of the photocatalyst treatment material 4 and then energy 5 is irradiated thereon via the photomask 6.

In a case in which a photomask is used as described above, a minute pattern can be formed by using the reduced projection exposure method in which the image of the mask pattern is reduced by using a reducing optical system. As such a photomask described above, a photomask formed on a metal plate such as a mask for vapor deposition, a photomask formed on a glass plate by using metal chrome, or further in a printing application, a film for making plate, and the like can be used.

(2) A Method of Forming a Pattern of the Light Shielding Portion on the Photocatalyst Treatment Material, and Irradiating Energy Thereon from the Side of the Photocatalyst Treatment Material

The present method is a method for cleaning a substrate in a pattern, without using the aforementioned photomask, but by using a light shielding portion formed in a pattern on a photocatalyst treatment material. In the present method, it is not necessary to use a photomask when irradiating energy, nor to carry out drawing irradiation by laser as described below. Accordingly, alignment of the photocatalyst containing layer side base material and the photomask is not necessary, so that the cleaning process is made simpler. Further, an expensive device required for drawing irradiation is also not necessary. In short, the present method has an advantageous in terms of the cost.

The light shielding portion used in the present invention may be formed by forming a film of a metal such as chrome by the vacuum film forming method or the like, and then etching the film in a pattern. Alternatively, the light shielding portion may be formed by forming a resin layer in which light shielding particles such as carbon black is dispersed in a resin, and then patterning the resin film by photolithography or the like. In the present method, the following three embodiments can be listed.

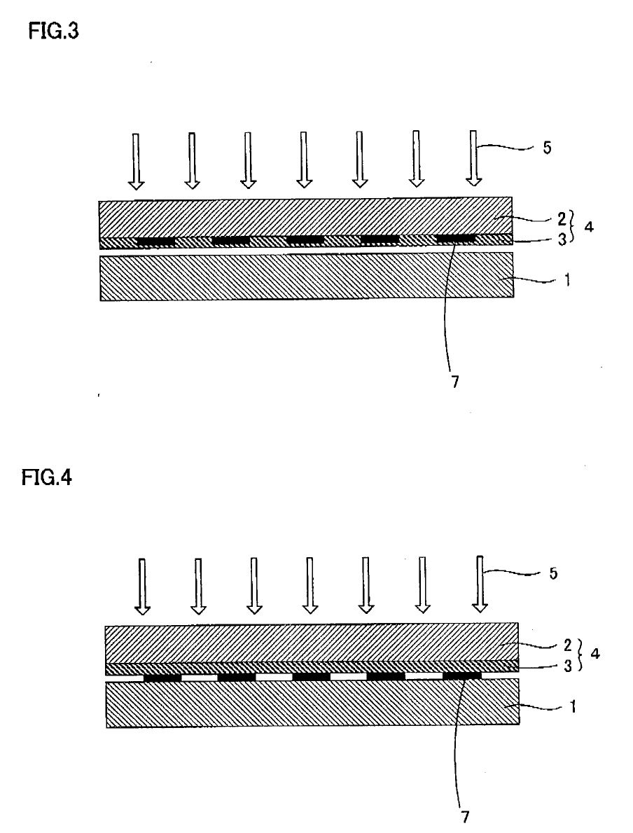

The first embodiment is, as shown in FIG. 3, a method in which a light shielding portion 7 is formed in a pattern on a base material 2, and a photocatalyst containing layer 3 is further formed thereon. According to this method, since the light shielding portion 7 can be placed in the vicinity of the surface of the substrate 1, deterioration in precision due to scattering of light and the like can be prevented. Further, although the easiness depends on the material of the base material 2, since the light shielding portion 7 is formed on the base material 2, the patterning process can be carried out easily, being advantageous. In this case, irradiation of energy 5 must be carried out from the base material 2 side of the photocatalyst treatment material 4.

The second embodiment is, as shown in FIG. 4, for example, a method in which a light shielding portion 7 is further formed in a pattern on a photocatalyst containing layer 3 formed on a base material 2. Advantages of this embodiment is, similarly to the first embodiment, that the high precision cleaning can be carried out in a pattern, because the light shielding portion 7 can be placed in an extremely vicinity of the surface of the substrate 1 to be cleaned. In addition, the pattern of the light shielding portion 7 can be used as a spacer.

That is, in the cleaning of the surface of the substrate 1, as described above, energy 5 is irradiated in a state in which the photocatalyst containing layer 3 and the substrate 1 are placed with a clearance provided between each other. By forming the light shielding portion 7 such that the thickness is equal to the thickness of the above described clearance, and placing so as the surface of the light shielding portion 7 and the surface of the substrate 1 are in close contact, placement of the photocatalyst containing layer 3 and the substrate 1 with an even clearance between the surfaces thereof can be easily maintained.

In the second embodiment in which the light shielding portion 7 is formed on the photocatalyst containing layer 3 as described above, the direction of the energy 5 irradiation is not particularly limited, and the energy 5 may be irradiated either from the side of the base material 2, or from the side of the substrate 1. Further, in this case, the irradiated energy such as light is not limited to those controlled to parallel, e.g., parallel light, and energy which is diffused light, e.g., radiation light, may also be used.

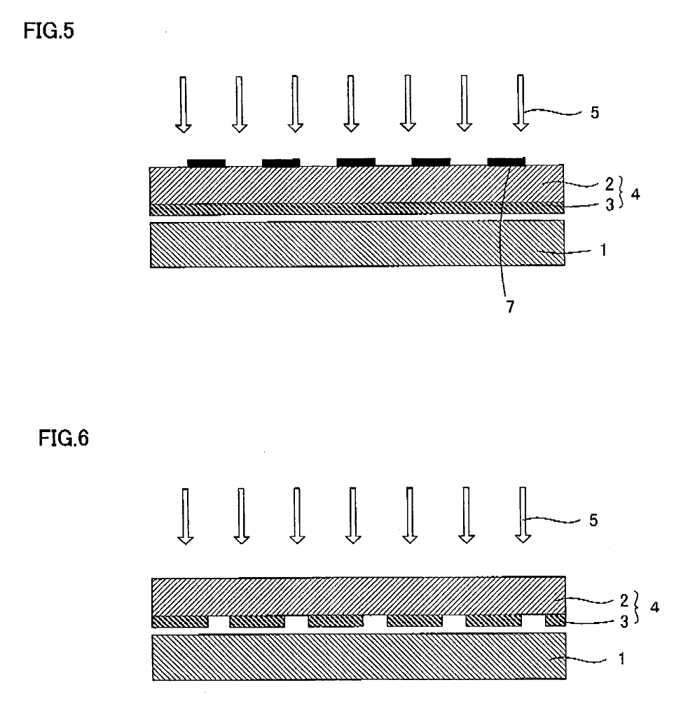

The third embodiment is, as shown in FIG. 5 for an example, an embodiment in which a photocatalyst containing layer 3 is formed on the base material 2, and a light shielding portion 7 is formed in a pattern on a surface of the side, opposite of the photocatalyst containing layer 3, of the base material 2. This embodiment has an advantage that a change or the like of the pattern of the light shielding portion 7 can be made without affecting the photocatalyst containing layer 3, although easiness of such change depends on the type of the base material 2.

In this embodiment, irradiation of the energy 5 must be carried out from the side of the base material 2 on which the light shielding portion is formed.

(3) A Method of Forming a Photocatalyst Containing Layer in a Pattern on the Base Material, and Irradiating Energy Thereon

The present method is a method in which a photocatalyst containing layer is formed in a pattern on a base material, and cleaning a substrate in the pattern. One example of this method is, as shown in FIG. 6, a method in which a photocatalyst containing layer 3 is formed in a pattern on a base material 2, the photocatalyst containing layer 3 and a substrate 1 are placed with no clearance or with a certain clearance between each other, and energy 5 is irradiated thereon, whereby cleaning the substrate 1 in the pattern. The method of patterning the photocatalyst containing layer is not particularly limited, as for example, it can be patterned by photolithography.

The irradiating direction of the energy 5 in this method, as shown in FIG. 6, may be either from the base material 2 side, or from the substrate 1 side. Further, the energy to be irradiated is not limited to those controlled to parallel, and energy which is radially irradiated may be used.

(4) A Method of Irradiating the Energy by Drawing Irradiation

The present method is a method for irradiating the energy by drawing irradiation. In an example of this method, as shown in FIG. 1, the photocatalyst containing layer 3 formed on the base material 2 and the substrate 1 are placed with no clearance or with a certain clearance between each other, and by energy 5 is drawing irradiated in a pattern by using laser such as excimer, YAG and the like, the substrate surface is cleaned in the pattern. Although FIG. 1 shows energy irradiation from the base material 2 side of the photocatalyst treatment material 4, the energy irradiation may be performed from the substrate 1 side.

(Organic EL Substrate)

The organic EL substrate of the present invention is characterized in that it was cleaned by the above described method. Facilities required for cleaning this organic EL substrate is inexpensive. Further, this organic EL substrate can be cleaned efficiently by a simple process in a short time. Therefore, it is possible to significantly reduce the cost for cleaning. Still further, cleaning in a pattern is possible, such that energy is not irradiated on a portion which is likely to be affected by energy irradiation. Therefore, it is possible to provide an organic EL substrate of high quality.

The present invention is not limited to the aforementioned embodiments. The above described embodiments are examples, and whatever having substantially the same configuration, and brings about the same operational effects as the technical thought described in claims of the present invention is incorporated in the technical range of the present invention.

### EXAMPLES

The present invention will be described further in details hereinafter, with reference to examples and comparative examples.

### Example 1

1. Formation of a Photocatalyst Treatment Material

30 g of isopropyl alcohol, 3 g of trimethoxymethyl silane (TSL8113, manufactured by GE Toshiba Silicones), and 20 g of ST-K03 (manufactured by Ishihara Sangyo Kaisha, Ltd.) as a photocatalyst inorganic coating agent, were mixed with each other and stirred for 20 minutes at 100° C. The mixture was diluted by threefold with isopropyl alcohol, whereby a composition for photocatalyst containing layer was obtained.

The thus obtained composition for photocatalyst containing layer was coated on a quartz glass base substrate by a spin coater. The coating was dried at 150° C. for 10 minutes, whereby a transparent photocatalyst containing layer (thickness being 0.15 μm) was obtained.

2. Cleaning of Silicon Wafer

A silicon wafer and the photocatalyst containing layer of the photocatalyst treatment material were faced to each other with a clearance of 5 μm, and cleaning by exposing by using Deep-UV lamp (10 mW/cm², 254 nm) for 50 seconds from the side of the photocatalyst treatment material.

The contact angle of the cleaned surface to water was measured, and the result was 10° or less.

Comparative Example 1

A silicon wafer was exposed for 50 seconds in a manner similar to that of example 1 without the photocatalyst treatment material. The measured contact angle to water was 45°.

### Example 2

1. Formation of Photocatalyst Treatment Material Provided with Light Shielding Portion

A photocatalyst containing layer was formed on a quartz glass substrate provided with a light shielding portion made of chrome, in a manner similar to that of example 1.

2. Cleaning of Photoresist Residue

A substrate on which a photoresist is patterned was aligned with the photocatalyst containing layer of the photocatalyst treatment material provided with the light shielding portion, so that the resist pattern is light shielded, faced with a clearance of 10 μm. Cleaning of the photoresist residues was carried out by exposing by using Deep-UV lamp (10 mW/cm², 254 nm) for 180 seconds from the side of the photocatalyst treatment material.

### Example 3

1. Formation of Photocatalyst Treatment Material Provided with Light Shielding Portion

A photocatalyst containing layer was formed, on a quartz glass substrate provided with a light shielding portion made of chrome, in a manner similar to that of example 1.

2. Cleaning of Electrode Substrate

An electrode substrate provided with a transistor was aligned with the photocatalyst containing layer of the photocatalyst treatment material provided with the light shielding portion, so that the transistor is light shielded, faced with a clearance of 200 μm. Cleaning of the portions except the transistor, was carried out by exposing by using Deep-UV lamp (10 mW/cm², 254 nm) for 50 seconds from the side of the photocatalyst treatment material.

From the measurement result, it was confirmed that no deterioration had been caused to the performance of the transistor.

What is claimed is:

1. A method for cleaning a substrate, wherein a substrate to be cleaned and a photocatalyst containing layer containing a photocatalyst, which is formed on a base material, are placed with no clearance or with a clearance between each other, and then, a surface of the substrate is cleaned by irradiating an energy from a predetermined direction.

2. The method for cleaning a substrate according to claim 1, wherein the substrate is formed with an inorganic material.

3. The method for cleaning a substrate according to claim 1, wherein the photocatalyst containing layer is a layer consisting of a photocatalyst.

4. The method for cleaning a substrate according to claim 3, wherein the photocatalyst containing layer is a photocatalyst film formed on the base material by a vacuum film forming method.

5. The method for cleaning a substrate according to claim 1, wherein the photocatalyst containing layer is a layer which comprises the photocatalys and a binder.

6. The method for cleaning a substrate according to claim 5, wherein the binder is an organopolysiloxane which is one kind, or two or more kinds of hydrolysis condensates or cohydrolysis condensates of silicon compounds represented by YₙSiX₍₄₋ₙ₎ (wherein Y denotes an alkyl group, a fluoroalkyl group, a vinyl group, an amino group, a phenyl group, an epoxy group, or an organic group containing the above, X denotes an alkoxyl group or halogen, and n is an integer of 0 to 3).

7. The method for cleaning a substrate according to claim 1, wherein the photocatalyst is one kind, or two or more kinds of materials selected from titanium dioxide (TiO₂), zinc oxide (ZnO), tin oxide (SnO₂), strontium titanate (SrTiO₃), tungsten oxide (WO₃), bismuth oxide (Bi₂O₃) or iron oxide (Fe₂O₃).

8. The method for cleaning a substrate according to claim 7, wherein the photocatalyst is titanium dioxide (TiO₂).

9. The method for cleaning a substrate according to claim 1, wherein the cleaning of the substrate surface is carried out on the entire surface.

10. The method for cleaning a substrate according to claim 1, wherein the cleaning of the substrate surface is carried out in a pattern.

11. The method for cleaning a substrate according to claim 10, wherein the cleaning of the substrate surface is carried out in a pattern, by forming the photocatalyst containing layer in a pattern on the base material.

12. The method for cleaning a substrate according to claim 10, wherein the cleaning of the substrate surface is carried out in a pattern, by forming a light shielding portion in a pattern on a surface of the photocatalyst containing layer.

13. The method for cleaning a substrate according to claim 10, wherein the cleaning of the substrate surface is carried out in a pattern, by forming a light shielding portion in a pattern on the base material.

14. The method for cleaning a substrate according to claim 10, wherein the cleaning of the substrate surface is carried out in a pattern, by irradiating the energy by photo drawing irradiation.

15. The method for cleaning a substrate according to claim 1, wherein the energy irradiation is carried out while the photocatalyst containing layer is being heated.

16. The method for cleaning a substrate according to claim 1, wherein the photocatalyst containing layer and the substrate surface are placed so as a clearance between each other is in a range of 0.2 to 10 μm, and then the energy is irradiated.

17. An organic EL substrate which is cleaned by a method for cleaning a substrate according to claim 1.
